(19) United States
(12) Patent Application Publication
(10) Pub. No.: US 2013/0124041 A1
(43) Pub. Date: May 16, 2013

(54) METHOD FOR ASSISTING A DRIVER OF A VEHICLE DURING A DRIVING MANEUVER

(71) Applicants: Florian Belser, Hechingen (DE); Michael Scherl, Bietigheim (DE); Steffen Knoop, Niefern-Oeschelbronn (DE)

(72) Inventors: Florian Belser, Hechingen (DE); Michael Scherl, Bietigheim (DE); Steffen Knoop, Niefern-Oeschelbronn (DE)

(21) Appl. No.: 13/579,890

(22) PCT Filed: Jan. 28, 2011
(86) PCT No.: PCT/EP11/51251

§ 371 Date: Jan. 25, 2013

(30) Foreign Application Priority Data
Feb. 18, 2010 (DE) 10 2010 002 105.9

(51) Int. Cl. G08G 1/16

(52) U.S. Cl. CPC G08G 1/16
USPC 701/41; 701/70

(57) ABSTRACT

In a method for assisting a driver of a vehicle in a driving maneuver, at least the surrounding area in front of the vehicle in the direction of travel is monitored, in order to detect objects with which the vehicle would collide if the vehicle maintained its direction of travel; in the event of an imminent collision with an object, a necessary steering action and/or a necessary braking action being indicated to the driver, and/or an automatic steering action and/or an automatic braking action being taken, in order to prevent a collision with the object. The contour of the body of the vehicle is taken into account for ascertaining if a collision with the object is imminent.

### BACKGROUND OF THE INVENTION

1. Field of the Invention

The present invention relates to a method for assisting a driver of a vehicle during a driving.

2. Description of the Related Art

Methods for assisting a driver during a driving maneuver that are known from the related art include, in particular, those that assist the driver, for example, while parking. So-called driver assistance systems, which either start automatically in response to a speed falling below a predefined speed or are manually activated by the driver, are generally used for implementing the methods. Systems, which assist the driver during parking maneuvers, include those that monitor the surrounding area of the vehicle and inform the driver about approaching objects. In this context, the informing of the driver may be accomplished, e.g., optically and/or acoustically. Additionally known are systems, in which the surrounding area of the vehicle is initially monitored and a possible trajectory for parking in a detected parking space is subsequently calculated. In order to follow the trajectory, it is known, on one hand, that the driver can be given necessary directions regarding longitudinal guidance and lateral guidance of the vehicle, or that, as an alternative, either the steering of the vehicle or also the steering and longitudinal guidance of the vehicle may also be taken over automatically.

Apart from systems that assist the driver during the parking of the vehicle, systems that supportively intervene to prevent a collision with an object are also known. Such a system is described, for example, in published German patent application document DE-A 10 2006 057 842. In order to assist the driver in the lateral guidance of the vehicle, the surrounding area of the vehicle is monitored in order to detect objects in the surrounding area of the vehicle and/or the course of a traffic lane used by the vehicle. If there is a risk of the vehicle colliding with one of the detected objects or leaving the detected traffic lane, then a lateral guidance system action is initiated for generating a course-correcting system yaw torque or a course-correcting system yaw rate. The lateral guidance system action may be interrupted by actuating the steering wheel of the vehicle, the accelerator pedal of the vehicle, and/or the brake pedal of the vehicle, if the degree of the specific actuation quantitatively differs from an actuation reference value assigned to the specific actuation by more than a predefined tolerance criterion.

One disadvantage of the method described in published German patent application document DE-A 10 2006 057 842 is that, in particular, in driving maneuvers that are performed at a low speed, it is not possible to closely pass an object, since the contour of the body of the vehicle is not taken into account.

### BRIEF SUMMARY OF THE INVENTION

In the method of the present invention for assisting a driver of a vehicle in a driving maneuver, in which at least the surrounding area of the vehicle in front of the vehicle in the direction of travel is monitored to detect objects, with which the vehicle would collide if it maintained its direction of travel, in which case, in response to an imminent collision with an object, a necessary steering action and/or a necessary braking action is indicated to the driver, and/or an automatic steering action and/or an automatic braking action is taken to prevent a collision with the object, the contour of the body of the vehicle is taken into account for ascertaining if a collision with an object is imminent.

In known systems, the vehicle is assumed to be a rectangular box. This also applies to parking systems, which calculate and follow their trajectory themselves. However, in the case of driving maneuvers that the driver performs, restrictions resulting from the assumption that the vehicle body is a rectangular box are not accepted by the driver. In general, the width decreases towards the front end of the vehicle, and corners of some vehicles are recessed by up to 15 cm in comparison with the head of the vehicle. Since in current systems, the vehicle body is regarded as a rectangular box and recessed regions are therefore not considered, a close pass, which would not lead to a collision on the basis of the actual body shape but would result in a collision when a rectangular body shape is assumed, is not taken into account. Therefore, due to the non-rectangular body shape, in many cases, it is possible to pass closer than is allowed by present systems that do not take the body shape into account. Since the driver can generally estimate the dimensions of his vehicle very accurately and therefore can drive by an object with very little clearance, he will not accept a greater clearance sometimes specified by a driver assistance system and will consequently not use the driver assistance system. Therefore, improved assistance to the driver during a driving maneuver may be provided by taking into account the contour of the body of the vehicle.

In particular, a simplified, two-dimensional representational shape, for example, a polygon, may be used for representing the contour. According to requirements, this is determined by the maximum dimensions of the body and by built-on parts relevant to a collision. However, the contour may also include a detailed 3-D model, which also takes into account the protruding regions, such as the front and rear ends of the vehicle, and the different elevations of the vehicle.

In one preferred specific embodiment, the driving maneuver is performed at a low speed. The speed at which the driving maneuver is performed is preferably less than 30 kilometers per hour, in particular, less than 20 kilometers per hour. In low-speed, high steering-angle maneuvers or parking events, a close pass of an object is generally desired. These are generally performed at low speeds, which means that the method of the present invention may be executed particularly advantageously in driving maneuvers, which are performed at a low speed.

In order to detect an object, it is necessary to monitor the surrounding area of the vehicle. To prevent collisions, it is particularly advantageous to monitor at least the surrounding area of the vehicle in front of the vehicle in the direction of travel. In the case of forward travel of the vehicle, in front of the vehicle in the direction of travel means the region in front of the vehicle; in the case of reverse travel, in front of the vehicle in the direction of travel means the region behind the vehicle. In addition, it is also possible to monitor the regions beside the vehicle. In particular, it is necessary to monitor the region that is covered by the vehicle during the drive. Distance sensors are preferably used for monitoring the surrounding area of the vehicle. In particular, distance sensors, which cover the short range, i.e., a range up to approximately 15 m in front of the vehicle, are used in this case. Suitable sensors that may be used include, e.g., ultrasonic sensors, radar sensors or LIDAR sensors. However, apart from these sensors, for example, capacitive sensors or video sensors, e.g., stereo-video systems, may also be used.

In one preferred specific embodiment, an automatic steering action is carried out in order to prevent a collision with an object, with which a collision would be imminent if the vehicle maintained its direction of travel. In order to carry out the steering action, the necessary path, which must be traveled to prevent a collision, is initially determined. The reaction time of the driver, which is necessary for preventing a collision, may also be included for calculating the evasion path. If the driver does not react, then an automatic steering action is carried out in order to prevent the collision.

In particular, the evasion path may include a curve, a trajectory or other descriptive geometric shapes.

In one preferred specific embodiment, an automatic braking action and/or a recommendation for a braking action only takes place, when a collision cannot be prevented by the automatic steering action and/or recommended steering action. The vehicle deceleration necessary for the braking action is described by the following relation:

$$a = \frac{{v}^{2}}{2 s} \cdot F ( d , s ) \qquad ( 1 )$$

In equation 1, a denotes the necessary vehicle deceleration, v denotes the speed of the vehicle, d is the distance of an object from the center of the travel route envelope to the vehicle contour along the travel route envelope curve. In this context, the travel route envelope is the region that is covered by the body during the drive.

In the case of cornering, the collision may also occur with the inner side of the vehicle. Therefore, distance s is determined between the obstacle and the collision location at the side of the vehicle. Function F(d, s) is used as a window function and excludes actions that are too early. For an emergency braking action, F(d,s) may equal 1 for values of s>0 and s−B(v)−D<0, and otherwise, 0. In this context, B(v) is the speed-dependent braking distance, and D is the safe distance from an obstacle. In this case, the safe distance is specified as a value. A customary safe distance is, e.g., 10 cm.

In order to prevent a collision, an evasion curvature is calculated as a function of steering angle, speed of the vehicle, contour of the body of the vehicle, and position of an object with which a collision is imminent. The evasion curvature then yields the evasion path, along which the vehicle must be moved in order to prevent the collision with the object.

In one preferred specific embodiment, a steering torque is calculated as a function of the distance of the vehicle from the object and the speed of the vehicle, as well as of the evasion path, in order to indicate to the driver a steering angle necessary to prevent a collision with the object. The applied steering torque causes the driver to carry out a steering movement, which is predetermined by the applied torque. Necessary steering torque M may be determined, for example, by the following equation:

M=p·k (2)

In equation 2, p denotes a proportionality factor, and k denotes the evasion path necessary to prevent a collision. In particular, the evasion path may be determined by calculating an evasion curvature. This is, in this context, a function of the assumed reaction time of the driver, e.g., 0.7 s, the speed of the vehicle, the contour of the vehicle, the distance of the obstacle from the center of the travel route envelope, and the distance of the next obstacle in the travel route envelope from the vehicle contour along the travel route envelope curve. Proportionality factor p is preferably selected in such a manner, that the maximum steering torque that occurs may be overridden by the driver, but that at low speeds, the frictional forces of the tires may also be overcome. Proportionality factor p may be advantageously selected as a characteristic curve or characteristics map dependent on vehicle quantities.

Coordinates s and d, which may be determined for each surrounding-area point monitored by the sensor system, are the basis for determining an evasion curvature. These surrounding-area points are converted from the local cartesian vehicle coordinate system into a (s, d) coordinate system, using the steering angle. In this connection, d has the meaning of the lateral distance from the center of the travel route envelope. If d has the value d=0, this means that an object is situated in the center of the travel route envelope. Thus, when driving straight ahead, d=y with y as a lateral cartesian object coordinate. In the case of cornering, the travel route envelope and its borders are a function of the curve traveled, as well as of the vehicle contour. The borders of the travel route envelope are defined by the corners of the vehicle contour having, in each instance, the greatest and least curvature. Thus, the center of the travel route envelope and, for example, its intersection with the rear axle, changes with the set steering angle. The variable s initially designates the longitudinal distance of a surrounding-area point along the travel route envelope; this corresponds to the arc length at a curvature defined by the steering angle. This arc length is advantageously defined as the distance to the contour and therefore corresponds to the path that can still be traveled until the surrounding-area point is reached.

In order to prevent a collision with the object with which a collision is imminent, the time for the automatic braking action is determined as a function of the position of the object with which the collision is imminent, the current steering angle, and the contour of the body of the vehicle. In this context, the time for the automatic braking action is ascertained such that it is possible for the vehicle to stop in a timely manner prior to the collision.

In one specific embodiment, the assistance to the driver during the driving maneuver is interrupted, if the driver applies a steering torque in opposition to the specified steering angle. To this end, it is necessary that the driver overcome the steering torque that is impressed upon the steering wheel. The overcoming of the steering torque indicates that the driver does not wish to follow the direction specified by the system. This is useful, for example, when there are two options for avoiding an object with which a collision is imminent, as is possible, for example, in the case of poles towards which the vehicle is traveling head-on. Alternatively, it is also possible that the driver is driving towards the obstacle head-on, but wishes to stop the vehicle prior to reaching the obstacle. This could be, e.g., poles or also masonry walls or partitions, which delimit a parking space from the front. In this case, the driver does not want an evasive maneuver, but wishes to continue driving straight ahead, directly towards the object.

If the assistance of the driving maneuver for the driver has been interrupted, e.g., since the driver has applied a steering torque in opposition to the recommendation, it is still possible for the driver to be assisted again if, after interruption of the assistance due to the steering angle selected by the driver, a possible, alternative trajectory for avoiding the object is reached. In this case, the alternative trajectory for avoiding an object, with which a collision is imminent, may be supported.

In one preferred, specific embodiment, information regarding the automatic steering action and/or the automatic braking action is indicated to the driver of the vehicle. In doing this, e.g., the planned direction may be indicated in the case of a steering action. In addition, it is advantageous for both information about the action itself, e.g., direction and intensity of the action, and/or also the reason for the action, to be indicated to the driver. The indication may be given, e.g., by a two-dimensional display of the surrounding area, including illustrated objects. The indication may assist the action, for example, by explaining the action to the driver of the vehicle, or, in some instances, may even take the place of the action. To that end, it is possible, for example, to only indicate the steering action and automatically execute a braking action, or to only indicate both actions. The driver may then follow the indication, in order to prevent a collision with the object with which the collision is imminent.

### BRIEF DESCRIPTION OF THE DRAWINGS

FIG. 1 shows a vehicle and a range of protection around the vehicle in the case of straight-ahead driving.

FIG. 2 shows a vehicle and a range of protection around the vehicle in the case of cornering.

FIG. 3 shows a vehicle and ranges of protection in the case in which an obstacle appears.

FIG. 4 shows a vehicle, along with a trajectory for preventing a collision.

FIG. 5 shows in a first specific embodiment, a travel route envelope, along with obstacles in the travel route envelope.

FIG. 6 shows in a second specific embodiment, a travel route envelope, along with obstacles in the travel route envelope.

FIG. 7 shows in a first specific embodiment, a function for calculating the steering action.

FIG. 8 shows in a second specific embodiment, a function for calculating the steering action.

FIG. 9 shows action intensity as a function of the function shown in FIG. 7.

### DETAILED DESCRIPTION OF THE INVENTION

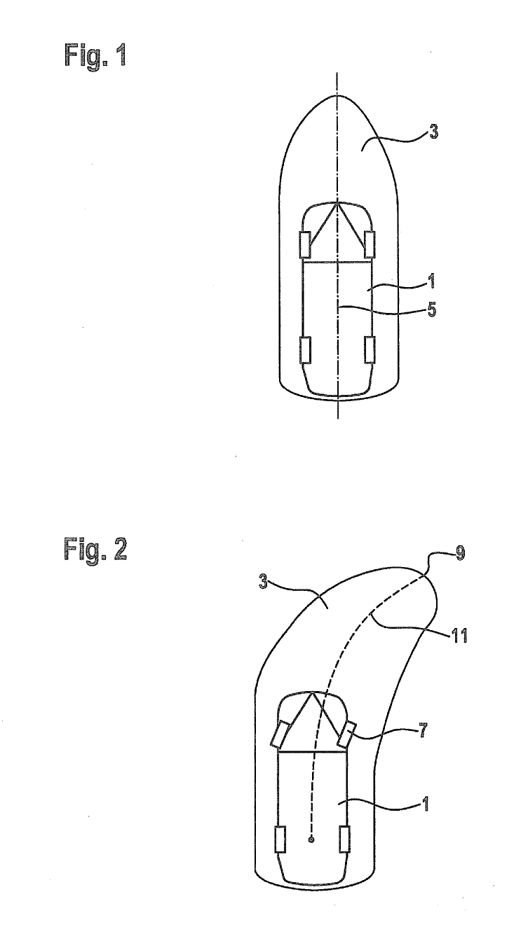

A vehicle and a range of protection around the vehicle in the case of straight-ahead driving are illustrated in FIG. 1.

In order to assist a driver of a vehicle 1 in a driving maneuver to the effect that collisions with objects in the surrounding area of the vehicle are prevented, a range of protection 3 is defined, in which objects that can lead to a collision with the vehicle are not allowed to be, in order for vehicle 1 to continue driving in an unhindered manner. Such objects include, e.g., other vehicles, walls, poles, or also people. Any other objects that may constitute obstacles, with which vehicle 1 may collide, must also be taken into consideration. Distance sensors are normally used for determining if objects are situated in range of protection 3. Suitable sensors include, e.g., ultrasonic sensors, radar sensors, LIDAR sensors or video sensors having distance data. The sensor types may each be used individually or also in combination. Sensors are normally positioned in the front part and in the rear part, in order to monitor the surrounding area of vehicle 1. In addition, it is possible to place sensors on a side of the vehicle, in order to monitor the region laterally next to the vehicle. Sensors that provide contour along with high-resolution directional data are particularly suitable as distance sensors. These include, e.g., LIDAR sensors or video sensors having distance data.

In the case of straight-ahead driving, range of protection 3 is symmetric with respect to axis 5 of the vehicle, as illustrated in FIG. 1. As long as no object detected by the sensors of vehicle 1 comes into range of protection 3, it is possible to drive straight ahead in an unhindered manner, and no action is necessary for assisting the driver in his driving maneuver.

Since, at a higher speed, evasive maneuvers must be initiated earlier and the braking distance is also longer, it is advantageous for range of protection 3 to be defined as a function of speed. Thus, it is possible, for example, to design range of protection 3 to be smaller with decreasing speed of vehicle 1.

A vehicle having a range of protection around the vehicle in the case of cornering is illustrated in FIG. 2. Unlike in the case of straight-ahead driving of vehicle 1, during cornering, in particular, the region in front of the vehicle in the turning direction must also be free of obstacles. In order to ensure this, it is possible, e.g., to deform range of protection 3 as a function of the steering angle. In FIG. 2, this is exemplarily illustrated for an occurrence of turning right. If front wheels 7 are steered to the right, then, in particular, the region in front of the vehicle, on the right, is covered by range of protection 3. To this end, as is illustrated in FIG. 2, it is possible, for example, to “deform” range of protection 3, such that tip 9 of the range of protection, which is furthest away from vehicle 1, is situated on planned trajectory 11 for the cornering. In the event of a change in the steering angle, and consequently, in the angle of front wheels 7, the shape of region of protection 3 also changes accordingly. In the case of turning left, the change in the shape of range of protection 3 proceeds specularly symmetrically to the specific embodiment illustrated in FIG. 2.

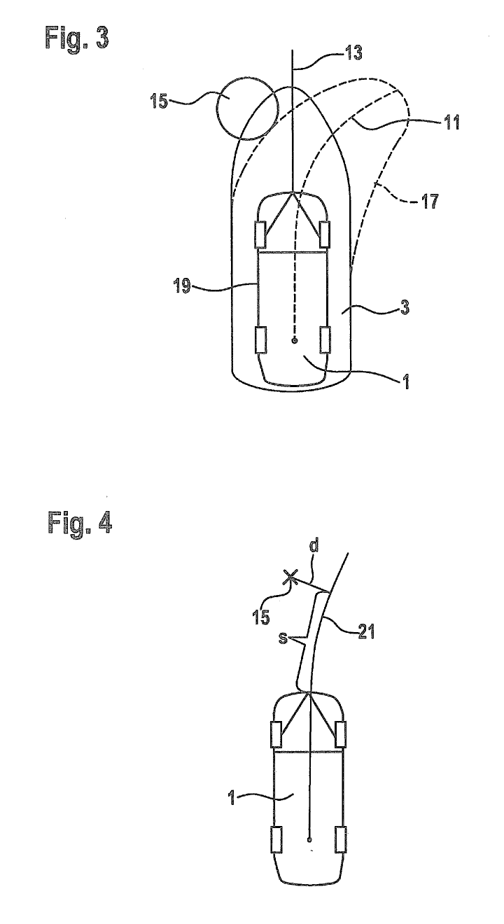

In the case in which an obstacle appears, a vehicle and ranges of protection are illustrated in FIG. 3.

A vehicle 1 and range of protection 3 of the vehicle for straight-ahead driving may be taken from FIG. 3. In this context, driving straight ahead is illustrated by a trajectory 13. According to the representation in FIG. 3, an object 15 juts into range of protection 3, which is supposed to be kept clear of objects in order to be able to drive straight ahead in an unhindered manner. In this case, object 15 is schematically illustrated as a circle and may be, for example, a person, a flower pot or any other object. In the case of a motionless object 15, continued straight-ahead driving of vehicle 1 leads to a collision with object 15. Such a collision is supposed to be prevented by the method of the present invention. If the driver does not initiate an evasive maneuver in a timely manner, an automatic steering action is carried out by vehicle 1. The path, which is traveled due to the automatic steering action, corresponds to trajectory 11 for cornering. In this context, trajectory 11 is calculated in such a manner, that range of protection 17 generated in response to trajectory 11 is shaped so that object 15 does not extend into range of protection 17.

In addition to steering vehicle 1, in this case, it may also be necessary, for example, to reduce the speed or to completely decelerate the vehicle, if a collision cannot even be prevented in the case of turning vehicle 1, as is illustrated in FIG. 3. In order to allow object 15 to be passed as closely as possible, in particular, in the case of driving slowly, i.e., at speeds <10 kilometers per hour, contour 19 of the vehicle is taken into account in the calculation of range of protection 3. Unlike in the case of known systems, in which vehicle 1 is normally depicted in the form of a rectangle, the consideration of contour 19 of the vehicle, in particular, in the corner regions of the vehicle, allows object 15 to be driven up to markedly more closely, as is also generally done by the driver of vehicle 1. By considering contour 19 of vehicle 1 in the determination of range of protection 3, e.g., the acceptance of the system by the driver of vehicle 1 may be increased in this manner. In addition, due to the possibility of passing an object 15 much more closely, evasion is frequently still possible with the aid of the driver assistance system that implements the method of the present invention, whereas in a system according to the related art, continuing to drive with the aid of the driver assistance system appears impossible, since on the basis of the modeling of the vehicle in the shape of a rectangle, it no longer appears possible to pass object 15.

In the case of the method according to the present invention, if an object 15 extends into range of protection 3 of vehicle 1, as illustrated in FIG. 3, then an action is taken by the driver assistance system that implements the method of the present invention. If evasion is only possible via a steering action, then only the steering action is carried out. If it is possible to drive around object 15 at a lower speed, then the speed of the vehicle is further reduced. Vehicle 1 is only decelerated to a dead stop in the case in which evasion is no longer possible.

In addition to assisting the driver of vehicle 1 in a parking event, the method of the present invention may also be used in any other maneuvers. Thus, the method may be used, for example, to prevent collisions with objects while driving slowly, e.g., in dead-end streets, while pulling into parking spaces or garages, or also while turning.

The driver assistance system used for implementing the method may be automatically activated while driving slowly, or manually switched on by the driver. If manual switching-on is possible, then this may take place via an arbitrary input device, as is provided in vehicles, for example, a switch, a multifunction pushbutton switch or a touch-sensitive video screen.

In order to prevent misuse and unclear transfer scenarios, it is advantageous to limit the speed, at which the method of the present invention is executed, to a low maximum speed of, for example, 30 kilometers per hour. Unclear transfer scenarios may occur, for example, when the driver exceeds a speed limit, at which the system may no longer ensure collision prevention, e.g., due to sensor operating ranges or processing latencies.

If the method of the present invention is used by the driver assistance system, it is advantageous that a torque be applied to the steering wheel of the vehicle. By this means, the driver receives information that the system is acting. However, there continues to be the option of the driver applying a steering torque in opposition to the system recommendation. To this end, it is necessary that the steering torque applied by the driver be greater than a defined threshold value. If this is the case, the steering torque applied by the driver is evaluated as an override request, and the system for implementing the method of the present invention is deactivated. However, as an alternative, the system may also continue to be active. In the specific embodiment illustrated in FIG. 3, if the driver turns the steering wheel to the left, for example, object 15 may also be passed on the left side, e.g., after a particular angle is reached. Consequently, the driver steers against a force, by which the original planning is overridden. However, as of reaching a steering angle at which it is possible to drive around object 15 on the other side, the assistance by the method of the present invention takes place again.

In addition, it is advantageous when an action by the driver assistance system is indicated to the driver, so that he is informed, e.g., via the action itself, for example, with regard to direction and intensity of the action. Furthermore, it is also possible to indicate the reason for the action to the driver. This may be accomplished, e.g., by a visual representation of the surrounding area, including marked obstacles. In this context, the visual representation may be implemented two-dimensionally or three-dimensionally on a suitable display device of the vehicle. In this connection, it is possible, for example, to provide a two-dimensional visual representation, which is constructed similarly to ultrasonically-based collision warning systems that are known from the related art and have an indicator in a display. In this context, the indicator may explain the action to the driver of vehicle 1 or possibly even take the place of the action. In this case, it is possible, for example, to only indicate a steering action and to automatically execute the braking action, or to only indicate both actions. In this case, the driver may then follow the indications with independent action.

A further option for determining a necessary steering action and/or braking action, in order to prevent a collision with object 15, is, e.g., to represent the range of protection as a potential field for steering action and braking action and to calculate an overlap of the vehicle region and objects. To this end, the potential field for the braking action is P_{B}(v,K) and the potential field for the steering action is P_{L}(v,K), where v is the current longitudinal speed and K is the current steering angle. Steering torque 1 and braking deceleration b are determined at each point i=1 . . . n of the quantization of the surrounding area of the vehicle by differentiation:

$${b}_{i} ∼ \frac{\partial {P}_{B} ( v , κ )}{\partial v}$$

$${l}_{i} ∼ \frac{\partial {P}_{L} ( v , κ )}{\partial κ}$$

Therefore, an action in the longitudinal and lateral direction is specified by each point in the surrounding area of the vehicle occupied by an obstacle. The resulting total braking action B and total steering action L are determined from all of the obstacle points in the surrounding area of the vehicle as follows:

$$B = max ( {b}_{i} )$$

$$and$$

$$L = max ( {\vert {l}_{i} \vert}_{{l}_{i} > 0} ) - max ( {\vert {l}_{i} \vert}_{{l}_{i} < 0} )$$

Therefore, for braking action B, the obstacle point that demands the most intense action is evaluated; for the steering action, the difference of the two actions, which respectively call for the most intense action to the left and to the right, is evaluated.

In order to obtain a suitably developed potential field for the braking action, it is possible, for example, to determine necessary braking deceleration a for preventing a collision with an object from relative speed v and distance s along a predicted trajectory 21. In this context, predicted trajectory 21 is the trajectory, which is followed by the vehicle in response to the current steering angle.

In the following, a stationary obstacle is assumed for the sake of simplicity. The braking deceleration constitutes the action taken by the driver assistance system and should result from the partial differentiation of the potential field.

The following applies to the braking deceleration:

$$a = \frac{{v}^{2}}{2 \cdot s} = \frac{\partial {P}_{B} ( v , κ )}{\partial v} .$$

Thus, the following relationship for potential field P_{B} may be indicated for the braking action:

$${P}_{B} ( s ) = \frac{1}{6 s} \cdot {v}^{3} \cdot F ( d , s ) ,$$

where s represents the distance of the obstacle along predicted trajectory 21 and d represents the perpendicular distance of object 15 from predicted trajectory 21. This is illustrated in FIG. 4.

Algorithms for calculating the actions and action intensity may be represented in a coordinate system as a function of the variables d and s.

In the specific embodiment described above, there are differently formed ranges of protection (or potential fields) for the steering action and the braking action. In this manner, it is possible to take into account the different characteristics of steering action and braking action. The shape of the range of protection for the steering action is at least a function of the current steering angle and, in some instances, additionally a function of the speed and acceleration of vehicle 1. The range of protection for determining the braking action is primarily a function of the speed of the vehicle, but, on top of that, may also be a function of the steering angle.

In one specific embodiment, it is also possible to determine steering action and braking action from the same potential field.

In one further specific embodiment, the steering action is not achieved by an additionally applied steering torque, but is autonomously set using steering-angle superposition. This produces a completely different driving feel for the driver: He “floats” through with the vehicle between the obstacles and only specifies the direction approximately. In this case, the system may be overridden, e.g., by switching off the driver assistance system, or also, for example, by turning in very sharply, or by a corresponding intervention in the longitudinal guidance, e.g., by actuating the accelerator pedal or brake pedal.

In addition to forward travel, as is illustrated here, the method of the present invention may also be used for reverse travel. In this connection, it is advantageous if, in response to engaging the reverse gear, the range of protection is turned around in such a manner, that the wedge recognizable in FIGS. 1 through 3 points backwards, and that thus, collision-free reverse travel is possible. In this case, the reverse travel is carried out analogously to the forward travel described above. In order to be able to execute such reverse travel, a corresponding rear-end sensor system, i.e., distance sensors that are situated in the rear part of the vehicle, is necessary.

The ranges of protection for steering action and braking action may additionally be formed according to subjective criteria. Thus, it is possible, e.g., by additionally superimposing an, e.g., asymmetric field for modeling human preferences, to prevent maneuvers that are physically correct but uncomfortable, or to give preference to others. For example, in a model, such a field may sensibly take into account that a driver normally masters passes of obstacles on the driver's side that are considerably tighter than on the passenger side. This is similar in the case of cornering during maneuvering situations. In this manner, it is possible for situations, which the driver himself would also avoid, to be avoided by the driver assistance system that implements the method of the present invention. However, if these are absolutely necessary, e.g., for preventing a collision, then they are still mastered by the driver assistance system.

In one alternative specific embodiment, it is also possible to calculate the necessary steering action and/or braking action without taking a derivative of a potential field. This may be achieved, e.g., in the following manner. Thus, the following relationship may be selected for the brake functionality:

$$a = \frac{{v}^{2}}{2 s} \cdot F ( d , s ) ,$$

where the function F(d,s) determines the situations in which, and the intensity with which, an action is carried out.

In this specific embodiment, e.g., the following formulation may be selected for a steering action:

$$λ = ET \cdot F ( d , s )$$

$$Δκ = \frac{2 λ}{2 {s}^{2}} .$$

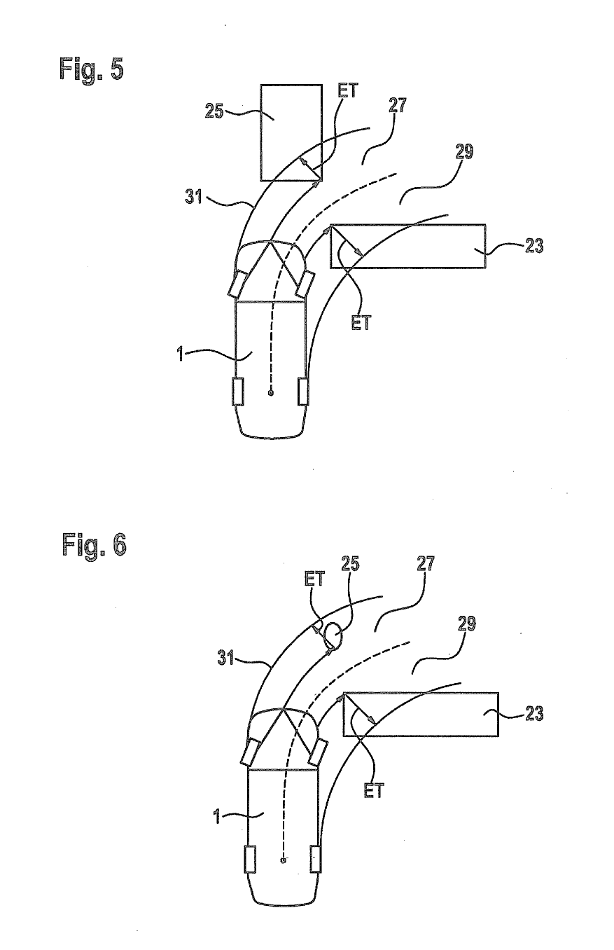

The object is to determine a desired change of steering angle Δκ. To this end, penetration depth ET of an object is ascertained from surrounding-area object data, and in light of the travel route envelope predicted from the current steering angle. In this context, the travel route envelope is the region that is covered by the vehicle while running past it. In order to provide assistance to the driver of vehicle 1 in a manner adapted to the situation, the travel route envelope may be weighted with a function F(d,s). This is illustrated in FIGS. 5 and 6 by way of example. To ascertain necessary steering actions and braking actions, in a first step, the penetration depth of objects 23, 25 is ascertained for left half 27 and right half 29 of travel route envelope 31 for each time step. In a subsequent step, the necessary or desired change in steering angle Δκ or the steering torque resulting from it is calculated. This may be selected to be linearly dependent, for example. In a third step, the action maxima for the left side and the right side of travel route envelope 31 are determined. In a final step, the left and right maxima are added up to obtain the actual steering angle or steering torque.

Penetration depth ET for two objects 23, 25 is shown in FIG. 5, where in any case, objects 23, 25 only extend partially into travel route envelope 31. In contrast to that, in FIG. 6, object 25 is completely in travel route envelope 31. In this case, penetration depth ET is determined on the basis of the point of the object 25 situated completely in travel route envelope 31, which point is furthest away from the edge of the travel route envelope.

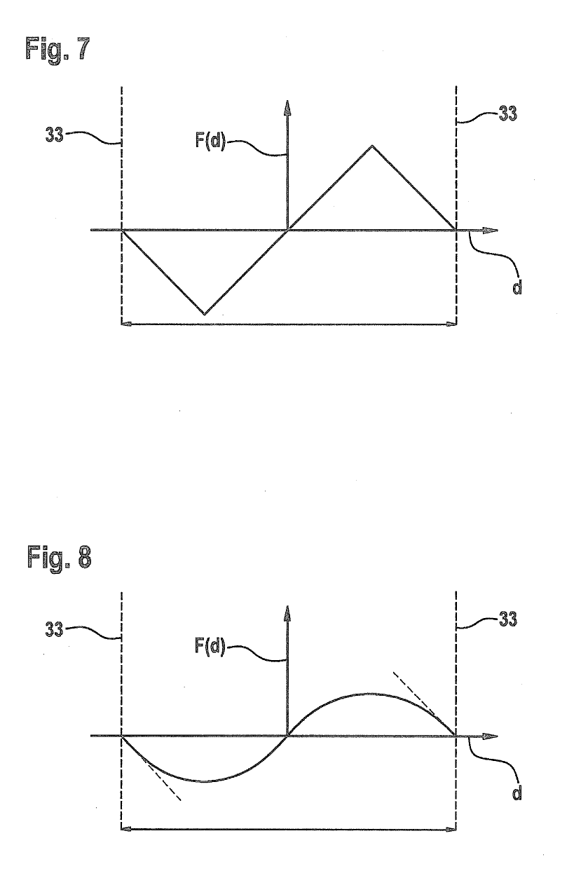

In a further specific embodiment, it is also possible to use the value of a function F(d) in place of penetration depth ET for calculating the steering action. This function is preferably symmetric with respect to the center of the travel route envelope. A first specific embodiment of a corresponding function is illustrated in FIG. 7, and a second specific embodiment of a corresponding function is illustrated in FIG. 8. In this connection, the distance of an object d is plotted on the x axis, and the value of function F(d) is plotted on the y axis. Borders 33 of travel route envelope 31 are illustrated by dashed lines. For example, the following properties may be characteristic of function F(d):
F(d)=0 for |d|> (width of travel route envelope)/2
F(d) is continuous
F((width of travel around envelope)/2)=0
The relationship F(d)−((width of travel route envelope)/2−d) may apply at the edges of the travel route envelope
In a further specific embodiment, function F(d) may be extended beyond the predicted edge of the travel route envelope, in order to ensure a safe distance in addition to the freedom from collision. For example, this may also be selected to be a function of the vehicle speed.

In order to calculate the action intensity, it is possible, over the left and the right halves of the travel route envelope 31, to initially determine separately, in each instance, the maximum action over the entire field of protection according to

$$l = \frac{F ( d )}{{s}^{2}} .$$

In this connection, on condition that obstacles are represented by measuring points in the detecting range, d always represents the distance of the measuring point on the obstacle from, in each instance, the closer edge of the travel route envelope. In other cases, one may proceed in an analog manner, e.g., using sampling methods. For each obstacle measuring point i=1 . . . n in the travel route envelope, the necessary action intensity 1ᵢ is calculated. Maximum action intensities I_{max,1} and I_{max,r} in the left and right halves of the travel route envelope are each added with different algebraic signs to obtain resulting action intensity Iᵣₑₛ.

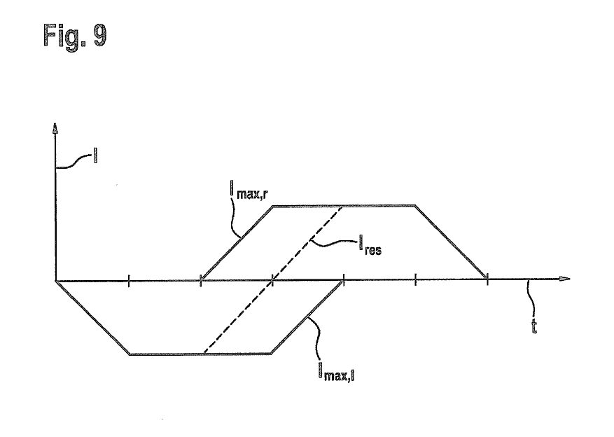

Using this method, e.g., the action intensities, shown in FIG. 9, for the left and right halves I₁ and Iᵣ, as well as for the resulting total action Iᵣₑₛ, are produced for a rectangular object. A rectangular obstacle of half the width of the travel route envelope, which moves from left to right across the travel route envelope, as well as the action function shown in FIG. 7, were provided a basis.

In FIG. 9, time t is represented on the x axis and action intensity I is represented on the y axis.

The method is advantageously not limited to scenarios including individual obstacles, since no information regarding the relationship of measuring point to object is used. Therefore, a contour of the objects is not a requirement for implementing the method, but can definitely be used as obstacle data in a further specific embodiment.

In a further specific embodiment, left and right halves of the travel route envelope 27, 29 are limited to two parallel strips in the travel route envelope, for example, along the predicted rolling path of the tires. Only obstacles, whose depth of penetration into these strips is greater than 0, are considered for the calculation of the action intensity.

1.-10. (canceled)

11. A method for automatically assisting a driver of a controlled vehicle in a driving maneuver, comprising:
monitoring at least a surrounding area in front of the vehicle in the direction of travel of the vehicle in order to detect at least one object with which the vehicle would imminently collide if the vehicle maintains the direction of travel, wherein the contour of the body of the vehicle is taken into account for ascertaining whether a collision with the at least one object is imminent; and
in the event of an imminent collision with the at least one detected object, automatically providing a driver assistance action including at least One of: (i) an indication to the driver regarding a necessary steering action to avoid the imminent collision; (ii) an indication to the driver regarding a necessary braking action to avoid the imminent collision; (iii) an automatic steering action to avoid the imminent collision; and (iv) an automatic braking action to avoid the imminent collision.

12. The method as recited in claim 11, wherein the driver assistance action provided only if the vehicle is traveling at a speed less than 30 km/h.

13. The method as recited in claim 12, wherein one of an ultrasonic sensor, a radar sensors or a LIDAR sensor is used for monitoring the surrounding area in front of the vehicle.

14. The method as recited in claim 12, wherein at least one of the automatic braking action and the indication to the driver regarding a necessary braking action to avoid the imminent collision is provided only if at least one of the automatic steering action to avoid the imminent collision and the necessary steering action by the driver to avoid the imminent collision is not available.

15. The method as recited in claim 12, wherein an evasion path is calculated as a function of a steering angle, speed of the vehicle, contour of the body of the vehicle, and a position of the at least one object.

16. The method as recited in claim 15, wherein a steering torque is generated as a function of the distance of the vehicle from the at least one object and the speed of the vehicle, and wherein the steering torque indicates to the driver a steering angle necessary to avoid a collision with the at least one object.

17. The method as recited in claim 15, wherein a time for the automatic braking action is determined from the position of the at least one object, a current steering angle and the contour of the body of the vehicle.

18. The method as recited in claim 12, wherein the driver assistance action is interrupted if the driver applies a steering torque in opposition to a steering angle specified by the driver assistance action.

19. The method as recited in claim 18, wherein the driver assistance action is resumed after the interruption if an alternative trajectory for avoiding the at least one object is reached after the interruption of the assistance.

20. The method as recited in claim 12, wherein information regarding at least one of the automatic steering action and the automatic braking action is indicated to the driver of the vehicle.
